(19) United States
(12) Patent Application Publication
(10) Pub. No.: US 2015/0019588 A1
(43) Pub. Date: Jan. 15, 2015

(54) Identifying Implicit Relationships Between Social Media Users To Support Social Commerce

(71) Applicant: Drexel University, Philadelphia, PA (US)

(72) Inventors: Christopher Yang, Cherry Hill, NJ (US); Xuning Tang, Arlington, VA (US)

(73) Assignee: DREXEL UNIVERSITY, Philadelphia, PA (US)

(21) Appl. No.: 14/327,754

(22) Filed: Jul. 10, 2014

Related U.S. Application Data
(60) Provisional application No. 61/845,010, filed on Jul. 11, 2013.

(51) Int. Cl. G06F 17/30

(52) U.S. Cl. CPC G06F 17/30864
USPC 707/776

(57) ABSTRACT

Assuming that an initial social network is unavailable because explicit connections between users are missing or incomplete, temporal analysis may be used to identify the implicit relationship between social media users. Temporal data may be used to extract implicit relationship regardless of their specific activities such as visiting the same web pages or commenting on the same web objects.

### BACKGROUND

In business applications, the social network may be widely used to represent customer relationships, buyer-seller relationships, or buyer-supplier relationships. For instance, in a customer relationship management system, customers and their relationships may be represented by a social network where each node denotes a customer and each edge corresponds to a relationship between two customers. In most of the situations, the users declare the network structure, especially for the links of a network. For example, in online social media sites, such as Facebook and Twitter, users can explicitly follow each other or accept a friendship request from another user. However, these explicit relationships are not always publically available, and these implicit relationships between users may be useful. FIG. 1 graphically shows explicit and implicit relationships.

Link prediction is the study of inferring implicit relationships among users. Inferring missing interactions among users may be highly probable to occur in the future. In a neighborhood-based link prediction approach, the probability of collaboration between two users may be computed by counting the common neighbors of two nodes in a collaborative network. Alternately, a score function may be employed that refines the simple counting of common neighbors by weighing rarer neighbors more heavily. Different from the neighborhood-based link prediction approaches, a path-ensemble based approach takes into account the distance between two nodes. A formula may measure the probability of a future link that sums over the paths between two nodes by weighting shorter paths more heavily. A normalized and symmetric version of hitting time may tackle the link prediction problem, where hitting time is the expected time in a random walk to reach a node starting from another node. A shorter hitting time corresponds to a higher proximity between two users. In addition to the neighborhood and path-ensemble based approaches, a classifier that takes proximity, aggregation and topological features into account to conduct link prediction may be used. Most of the existing link prediction techniques, however, need a social network as an initial input and their objective is predicting future interactions given the current network snapshot.

### SUMMARY OF THE EMBODIMENTS

A method for identifies social relationships between users remote to one another and interacting through a social platform, wherein the relationship between users is identified using temporal analysis that identifies a users' activeness.

In this disclosure, it may be assumed that an initial social network is unavailable because explicit connections between users are missing or incomplete. Instead, a temporal analysis may be used to identify the implicit relationship between social media users.

Temporal data nay be used to extract implicit relationship regardless of their specific activities such as visiting the same web pages or commenting on the same web objects.

User activeness may be represented by a time series, namely a user feature vector, and user behavior may be investigated by spectral analysis techniques. Spectral coherence scores between two user feature vectors may be used to represent their potential relationships.

Signal processing techniques, which have been investigated in a wide variety of fields including genetics, economics, and neuroscience, may also be applied to extract semantically related search engine queries and cluster words in news streams to detect popular events. The signal processing techniques may be employed to analyze the user frequency of social medial activities and determine the implicit relationship between any two users even if these two users do not have any explicit interaction or relationship.

### BRIEF DESCRIPTION OF THE DRAWINGS

FIG. 1 is a graph of Threshold vs. F1 measure.

FIG. 2 graphically shows explicit and implicit relationships.

FIG. 3 is the pseudo code of the Mutual Top-K Filtering Algorithm, where N denotes the total number of users.

### DETAILED DESCRIPTION OF THE EMBODIMENTS

### Introduction

The Internet is an ideal platform for business-to-consumer (B2C) and business-to-business (B2B) electronic commerce where businesses and consumers conduct commerce activities such as searching for consumer products, promoting business, managing supply chain and making electronic transactions. The success of many electronic commerce retailers such as Amazon and eBay has proven that the Internet is an ideal platform for electronic commerce. In recent years, following the success of MySpace, Facebook, and Twitter, social media has drawn significant attention in electronic commerce. Social media may facilitate the electronic commerce services and stimulate the electronic commerce transactions. Social commerce, which is considered as part of electronic commerce, draws increasing interest from academics and industry in developing new theories and technologies to understand the user behavior of social media and extract knowledge from the user-contributed content and social network structure.

Social commerce may include other applications as well, such as security applications. An analysis of user interaction on websites may lead to identifying interactions that raise security concerns, depending on interests shared, discussed, and proximity of users.

Social network analysis and mining techniques are powerful tools used in identifying influential users, discovering special interest subgroups, determining user roles, and understanding community evolution. These techniques help to understand the development of electronic commerce user interest for matching products with potential consumers. Social network analysis and mining may be used with a social network that captures the ties between actors as input. In conducting social network analysis and mining on social media, there may be a desire to capture the user relationships of common interest. Social media is a large space that involves a tremendous number of users and interactions. The explicit interactions between users may only represent part of the user relationships but many users who have common interests may not necessarily interact with each other explicitly.

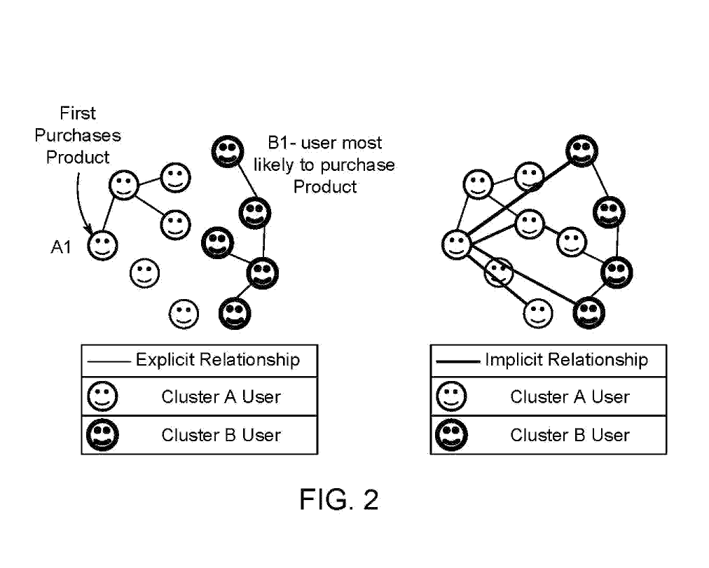

A user relationship may be classified as having two aspects: an explicit relationship and an implicit relationship, as shown graphically in FIG. 2. The explicit relationships between clusters of users A1 and B1 may be the relationship that can be captured by the user's direct interaction through the functions in social media sites. For example, a Web forum first user makes a comment on a post made by another user; a Twitter user retweets a tweet posted by another Twitter user; a Facebook user accept a “friend request” from another Facebook user. These explicit interactions between two social media users indicate a relationship between them because of their common interest in a particular content/action or an intention of building a close relationship.

The implicit relationships, shown by thicker lines in FIG. 2, correspond to the relationship drawn from the user coherent interest or activity that cannot be traced by any public records of interactions between two users in a social media site. Thus, as shown in the more developed relationship tree in FIG. 2, the cluster A users and cluster B users share a network of interests and contacts that was not clear when looking at just the explicit relationships.

Extracting implicit relationships between users may be more challenging. Two users who have common interest on certain content may behave similarly to follow the related events; but these two users may not have any direct interaction with each other. For example, two users who are interested in a particular movie may post comments or tweets about their opinions on the movie when they see the trailers or news of this movie on the Web. These two users, however, may not have any direct interactions or comment on each other's opinions.

From the electronic commerce perspective, identifying the implicit relationship between users provides valuable information for marketing and recommending consumer products to potential consumers may overcome the sparseness of ties in social networks constructed by explicit relationships. A temporal analysis approach may address the challenge of identifying implicit relationships between online social media users.

Comparing the performance of the proposed implicit relationship identification techniques with the explicit relationship extractions has shown that the proposed implicit relationship identification techniques obtain a higher F−1 measure value. Some techniques described herein may discover implicit relationships based on user similarity such as the notion of homophily that considers that social relationships are likely to form between people of similar characteristics. Another technique introduces methods for extracting “quasi-social network” from data on visitations to social networking pages. A link placed between two users in this “quasi-social network” depends on their visits to the common web pages. Similarly, proximity may also be interpreted as interaction in physical spaces. This explicit quasi-relationship may not always be available in all social media sites.

### METHOD

### Temporal Analysis

Direct user interactions may be useful in extracting explicit relationships but may face challenges to identify implicit relationships. Indeed, the implicit relationship cannot be determined by simply tracing the one-to-one interaction between users. By identifying and integrating implicit relationships, the method herein may be able to obtain a more comprehensive view and achieve better social media analytic performance. This section describes a temporal analysis research framework to identify implicit relationship from online social media.

Temporal Coherence Analysis

Web users generate most web content. External events, such as the release of new iPhone 4s or the anniversary sale of a famous brand, may trigger a mass of web content contributed by web users with common interest. As a result, even though two users do not explicitly interact with each other, as long as they react similarly to common external events, it is possible that these two users might share common interest or have an implicit relationship. In other words, assume that an implicit relationship exists between two users when their daily activeness has strong temporal coherence. One objective of temporal coherence analysis is calculating the temporal similarities between any pair of users, which will result in a similarity matrix to represent the strength of implicit relationships between users. To quantify the similarity between any pair of users, say i and j, the method may first represent them by user feature vectors, then computes auto-spectrum for each individual vector and cross-spectrum of i and j, finally the spectral coherence of i and j is employed to quantify their similarity.

User Feature Vector

In the method, vectors represent users. Given any online social media, let T be the period (in days) during which user behavior and interaction are investigated. For each user, the method represents their activeness by a vector defined as below:

Aᵤ=[Aᵤ(1),Aᵤ(2), . . . ,Aᵤ(T)] (1)

where each element Aᵤ(i) represents the activeness of user u on the ith day. Aᵤ(i) can be defined in a flexible manner according to the context. Several attributes can be used to quantify user activeness depending on which online social media is being studied, for example, the number of messages a user posts daily, the number of URLs a user tags daily, the number of tweets a user posts or retweets daily, or the number of videos a user clicks and comments daily. In a simple manner, Aᵤ₍(i) can be defined as:

$${A}_{u} ( i ) = \frac{{N}_{u} ( i )}{N \text{(} \text{i} \text{)}} \qquad ( 2 )$$

where Nᵤ (i) is the number of messages posted by user u on day i, N(i) is the total number of messages posted by all users including u on day i. Aᵤ (i) may be defined in more precise ways when more user information is given.

The method described herein focuses on the implicit relationships among users in online social media (data from Digg.com will be used as a test bed herein). Given all the user contributed content or user actions Aᵤ(t) is defined

$${A}_{u} ( i ) = \frac{{M}_{u} ( i )}{M \text{(} \text{i} \text{)}} \times log ( \frac{S}{{S}_{u}} ) \qquad ( 3 )$$

where Mᵤ(i) is the number of messages (stories or comments) contributed by user u on day i, M(i) is the total number of messages contributed by all users including u on day i, Sᵤ is the total number of unique threads that user u participated (submitted or made comments to) over time T, and S is the total number of unique threads over T. Equation (3) consists of two components:

$$\frac{{M}_{u} ( i )}{M \text{(} \text{i} \text{)}} and log ( \frac{S}{{S}_{u}} ) . \frac{{M}_{u} ( i )}{M \text{(} \text{i} \text{)}}$$

measures the number of messages that user u contributes on day i normalized by the total number of messages of day i. The higher Mᵤ(i) is, the more messages that u contributes, leading to a larger activeness of u at day

$$i . log ( \frac{S}{{S}_{u}} )$$

penalizes a user if they participated in too many different stories because this may imply that this user does not have a specific focus.

Consider a group of m users form an m-dimensional multivariate process. By employing the user feature vector defined above, the m-dimensional multivariate process can be denoted as A, where each row denotes a user and each column indicates the activeness of these users on a specific day:

$$A = {( {A}_{1} , {A}_{2} , ⋯ , {A}_{m} )}^{T} = ( \begin{matrix}{A}_{1} ( 1 ) & ⋯ & {A}_{1} ( T ) \\ ⋮ & ⋱ & ⋮ \\ {A}_{m} ( 1 ) & ⋯ & {A}_{m} ( T )\end{matrix} ) \qquad ( 4 )$$

Spectral Analysis

User behaviors in terms of multivariate time series are often rich in oscillatory content, leading them naturally to spectral analysis. By computing the spectrum of user i, the method may quantify the overall activeness of a user in online social media. To calculate spectral estimates of users (auto- or cross-spectrum and coherence), a Fourier transform is performed on each Ai. Given a finite length user feature vector of discrete time process Aᵢ(t), t=1, 2, . . . , T, the Fourier transform of the data sequence Ãᵢ (f) is defined as follows:

Ãᵢ(f)=Σₜ₌₁^{T}Aᵢ(t)exp(−2πift) (5)

A simple estimate of the spectrum is taking the square of the Fourier transform of the data sequence, i.e., |Aᵢ(f)|². This may suffer, however, from the differences of bias and leakage. To resolve these issues, the method applies multitaper technique to obtain smoother Fourier-based spectral density ith reduced estimation bias. In the multitaper technique, the method applies K tapers successfully to the ith user feature vector and takes the Fourier transform:

Ãᵢ(f,k)=Σₜ₌₁^{T}wₜ(k)Aᵢ(t)exp(−2πift) (6)

where wt(k) (k=1, 2, . . . , K) represent orthogonal taper functions with appropriate properties. A particular choice of these taper functions, with optional leakage properties, is given by the discrete prolate spheroidal sequences (DPSS). The multitaper estimates for the spectrum Si(t) is defined as:

$${S}_{i} ( f ) = \frac{1}{K} {\sum }_{k = 1}^{K} {\vert {\tilde{A}}_{i} ( f , k ) \vert}^{2} \qquad ( 7 )$$

Since the spectrum score of each user varies with different frequency, which implies that a user performs differently at different period, in this work, the method defines the dominant power spectrum of user i as its maximum spectrum value across all potential frequencies:

Sᵢ=Max_{f}(Sᵢ(((f) (9)

where Ã_{L} (f,k)* denotes the complex-conjugate transpose of Ãᵢ(f, k). This gives the spectral density matrix for the multivariate processes A as:

$$S ( f ) = ( \begin{matrix}{S}_{1 , 1} ( f ) & ⋯ & {S}_{1 , p} ( f ) \\ ⋯ & ⋱ & ⋯ \\ {S}_{p , 1} ( f ) & ⋯ & {S}_{p , p} ( f )\end{matrix} ) \qquad ( 10 )$$

with the off-diagonal elements representing cross-spectrum and diagonal elements representing auto-spectrum.

Measure Users' Similarity by Spectral Coherence

The method may quantify the similarity of two user feature vectors by using spectral coherence. Spectral coherency for any pair of user feature vectors Ai and Aj is calculated as:

$${C}_{i , f} ( f ) = \frac{{S}_{i , j} ( f )}{\sqrt{{S}_{i , i} ( f ) {S}_{j , j} ( f )}} \qquad ( 11 )$$

Spectral coherency is a complex quantity that provides estimation of the strength of coupling between two processes. Its absolute value is called spectral coherence with ranges from 0 to 1. A spectral coherence value of 1 indicates that the two signals have a constant phase relationship, and a value of 0 indicates the absence of any phase relationship. Although correlation can also indicate the coupling between two user feature vectors, the method chooses spectral coherence here since it does not only show how similar two user feature vectors are, but also informs a user that at which frequency these two user feature vectors are similar. The method may obtain an overall spectral coherence score for each pair of users by summing over their spectral coherence value in different frequency, which gives

C_{i,j}=Σ_{f}C_{i,j}(f) (12)

It is important to note that this spectral coherence score between two users is employed to represent the similarity of two users across all frequencies. It can be used in many practical applications.

Filtering Algorithm

Given a similarity matrix of users, two kinds of filtering algorithms to construct networks may be used. One is Mutual Top-K Filtering and the other one is simple Thresholding.

Mutual Top-K Filtering

Given a similarity matrix, for each user I, the method sorts the similarity scores between I and all other users in the descending order and retrieves k users that have the top k similarity score with i, denoted as Candidate (i). Parameter k is provided as an input, which is a percentage, indicating the proportion of users retrieved. As a result, i has a relatively higher similarity with users in Candidate(i). Secondly, for each users j in Candidate(i), whether i also belongs to Candidate(j) is checked to ensure that t has a relatively high similarity with i too. If it is true, j in Candidate(i) is retained, otherwise j is removed from Candidate(i). The method ensures that each user will be associated to at least one other user. As a result, if Candidate(i) is an empty set, the method correlates i with the user p that has the highest Ci,n. At last, except for relationships in candidate(i) where I from 1 to N, all other elements in the similarity matrix may be set to equal zero. By considering the original similarity matrix as a fully connected network, this filtering step removes edges with relatively lower weights (similarity scores) and constructs a network.

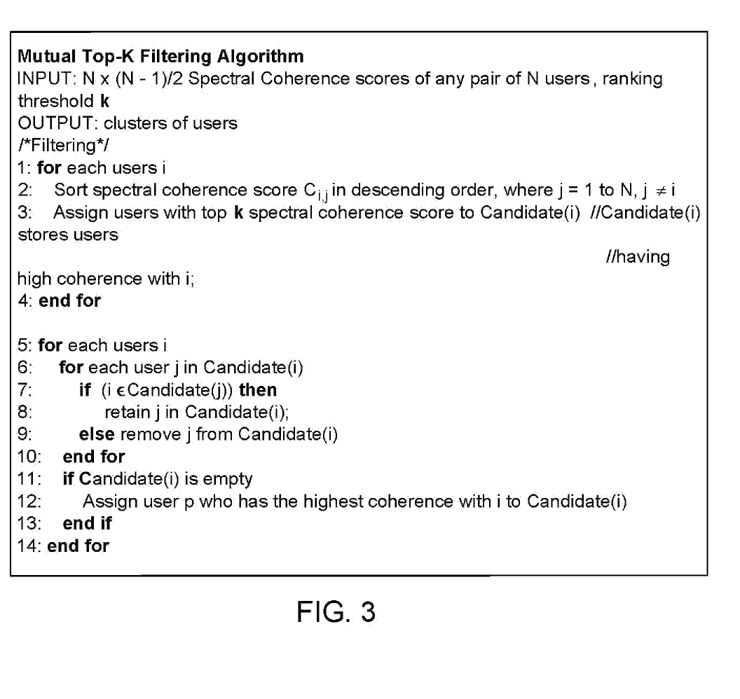

FIG. 3 is the pseudo code of the Mutual Top-K Filtering Algorithm, where N denotes the total number of users.

Thresholding

As in Mutual Top-K Filtering, for each user i, the method also sorts the similarity scores between i and all other users in the descending order. In this method, however, after calculating the similarities for each pair of users, the method retains the pairs whose similarity are larger than a predetermined threshold k and removes the rest.

### EXAMPLE

Dataset

In a nonlimiting example, the method uses the social media site, Digg.com, as testbed. Digg.com provides a platform for Web users to submit stories for discussions.

Users who find interest in a story can make comments or “dig” a story. For each story in Digg.com, its story ID, submitter user ID, IDs of all the comments of this story, user IDs of all commenter, and the corresponding timestamps, were collected and saved in the dataset.

Then the Digg API was used to collect the dataset from Digg.com and five popular newswires and all stories of these newswires submitted by Digg users to Digg.com for discussions were selected. These five news sources were: CNN, BBC, NPR, The Washington Post, and Yahoo! News. During a three-month span, all the “top news” (which are defined and recommended by Digg.com), comments of all these stories, all user information and timestamps were collected. Specifically, for each story collected, its story ID, submitter ID, brief abstract of the story, all comments and the commenter's IDs, and the corresponding timestamps for both the story and the comments were recorded. In total, there were 12,742 stories, 13,531 comments (only 590 stories have comments) and 286 active users (defined as users who were active in more than 10 days during this 3 month period to be active users and filtered the inactive ones).

Gold Standard

To evaluate the performance of the proposed techniques, annotators analyzed the dataset and generated a Gold Standard. The generation of this gold standard included the following steps. 1) 50 pairs of Digg users in the dataset were selected randomly, 2) the annotators independently examined all the stories and comments submitted by each pair of users, identified the subjects of each story or comment, and determined the areas that each user was most interested in, 3) the annotators independently identified if a relationship of common interest existed between each pair of users.

To determine the reliability of the Gold Standard produced by the two annotators, the weighted Kappa measure was used to compute the inter-rater agreement. Weighted Kappa measure is a statistical measure extended from Kappa measure for computing the agreement between two ordered lists. It has a maximum value of 1 when there is perfect agreement between two raters and a value of 0 when the agreement is not better than by chance. In general, a weighted Kappa measure value larger than 0.8 is considered a very good agreement between the two raters. In the experiment, the weighted Kappa measure was 0.84, which means the two annotators had a good agreement and the Gold Standard was reliable for the experiment.

Baseline Method

To test the effectiveness of the proposed techniques, the proposed technique was compared with two baseline methods, 1×N and N×N, which only consider explicit interactions. For each story in the dataset, user ID of the submitter and the Digg users who made comments on this story were gathered. The 1×N method constructs a 1 to N network where each link corresponds to an interaction between the submitter and a commenter of the story. In the 1×N method, the explicit relationship between two users when the submitter of a story received a comment from another Digg user were considered. The N×N method constructed a fully-connected network where any two users within a same story, including story submitter and all commenters, were connected by links. In the N×N method, in addition to the “submit and comment” explicit interaction, an explicit relationship occurs between two users when they are commenting on the same story that both of them are interested in were considered.

Measurement

Precision, recall, and F−1 measures were used as the metrics to evaluate the performance of the proposed techniques. These metrics are measured in terms of four parameters true positive (TP), false positive (FP), true negative (TN) or false negative (FN) as illustrated in Table 1.

TABLE 1
TP, FP, TN, and FN

| | |
|---|---|
| | Temporal |
| | Analysis |
| Human | Algorithms |

| Annotators | Yes | No |
|---|---|---|
| Yes | TP | FN |
| No | FP | TN |

“Yes” denotes that the relationship was determined by an algorithm or the human annotators; “No” denotes that there is no relationship between the two users determined by an algorithm or the human annotators. If both an algorithm and the human annotators determined a relationship, it is a TP. The formulations of Precision, Recall, and F1-Measure are presented below.

Precision: the number of TP divided by the number of TP plus FP.

Precision=TP/(TP+FP)

Recall: the number of TP divided by the number of TP plus FN.

Recall=TP/(TP+FN)

F1-Measure: a harmonic mean of precision and recall which is defined as:

F1-Measure=2×Precision×Recall/(Precision+Recall)

Results

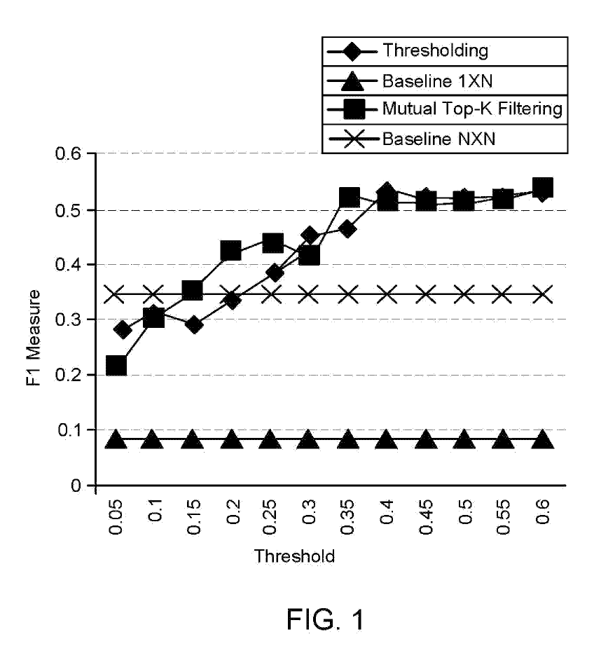

In this experiment, the results of Digg users' relationships generated by human annotators as the Gold Standard were used. The baseline approach and techniques on the same dataset were separately applied to generate the results of the relationships among Digg users. Both the 1×N and N×N baseline methods were employed to identify Explicit Relationship (ER), whereas both of the proposed Thresholding and Mutual Top-K Filtering approaches were used to identify the Implicit Relationship (IR). The results produced by each approach were compared with the Gold Standard respectively. Table 2 demonstrates the Recall and Precision trend, and FIG. 1 presents the F1 measures of each approach.

TABLE 2
Recall-Precision

| Threshold | Recall | Precision | Recall | Precision |
|---|---|---|---|---|
| | IR (Thresholding) | | IR (Mutual Top-K Filtering) | |
| 0.05 | 0.17391 | 0.6667 | 0.13043 | 0.60 |
| 0.1 | 0.21739 | 0.55556 | 0.21739 | 0.50 |
| 0.15 | 0.21739 | 0.45455 | 0.26087 | 0.54545 |
| 0.2 | 0.26087 | 0.46154 | 0.34783 | 0.53333 |
| 0.25 | 0.30435 | 0.50 | 0.3913 | 0.50 |
| 0.3 | 0.3913 | 0.52941 | 0.3913 | 0.45 |
| 0.35 | 0.43478 | 0.50 | 0.52174 | 0.52174 |
| 0.4 | 0.52174 | 0.54545 | 0.52174 | 0.50 |
| 0.45 | 0.52174 | 0.52174 | 0.52174 | 0.50 |
| 0.5 | 0.52174 | 0.52174 | 0.52174 | 0.50 |
| 0.55 | 0.52174 | 0.52174 | 0.56522 | 0.48148 |
| 0.6 | 0.56522 | 0.50 | 0.6087 | 0.48276 |
| | ER(1 × N) | | ER (N × N) | |
| | 0.043478261 | 1.00 | 0.217391304 | 0.833333333 |

As shown in Table 2, both Thresholding and Mutual Top-K Filtering approaches outperform the two baseline methods as the threshold increased, but the difference between the Thresholding and Mutual Top-K Filtering is not substantial. The baseline methods, either 1×N or N×N, achieve very high precision (i.e Precision=1.00 for 1×N and Precision=0.83 for N×N). This is because the number of explicit relationships that can be identified by 1×N and N×N is small but the extracted explicit relationships are true relationships. However, the recall is extremely poor (i.e. Recall=0.04 for 1×N and Recall=0.22 for N×N). This is because many true relationships cannot be extracted by the explicit relationships. On the other hand, the Thresholding and Mutual Top-K Filtering suffer in lower precision but they achieve substantially higher recall. That means the implicit relationships identification can extract substantially more true relationships; however, it also may extract more false relationships. FIG. 1 shows that both Thresholding and Mutual Top-K Filtering obtain better results than 1×N baseline method in F1 measure. Thresholding appears superior to N×N baseline method in F1 measure with the threshold larger than 0.2, while Mutual Top-K Filtering with threshold larger than 0.15. And the difference increases as the threshold increases. By identifying the implicit relationships among Digg users, the proposed techniques may identify user relationship better than relying on explicit user relationships.

The two baseline approaches based on explicit interactions achieved relatively higher precision but lower recall, which means that an explicit interaction between web users is an effective indicator to determine if two users have common interest. Unfortunately, these explicit interactions may capture a small percentage of potential relationships between web users. Indeed, using the explicit interactions may recall less than 22% of user relationship of common interest.

The temporal analysis technique may identify the implicit relationships. As shown in FIG. 1, using F−1 measure, the technique consistently outperformed the 1×N baseline. In addition, as the threshold increases, these two proposed approaches also substantially outperformed the NXN baseline method. The technique, however, may yield more false positives.

By incorporating both implicit and explicit relationships with a logical OR operation, the performance can be further improved by 20% to 100% in F−1 measure depending on the threshold value. Since most of the extracted explicit relationships are not the same as the extracted implicit relationships, the performance can be substantially increased when incorporating both techniques.

The true positives may be considered relevant when the extracted relationships are used to recommend social media users to promote interactions. The social media sites have a large volume of user-contributed content as well as a large number of users. It is nearly impossible for any social media user to follow the relevant information from such a huge content space and user space. Each social media user is typically aware of the existence of a relatively small number of users who have the common interest. It explains why there are so many isolated communities in social media. Unless there is a good recommendation system to feed the social media users about other users of common interests, the interactions in social media will still be limited. Identifying the true positives is important to connect the users and communities together even with the sacrifice of offering false positives. It takes the user effort to filter the false positives but the users can identify substantially more potential relationships that they are not aware of otherwise. On the other hand, if a recommendation system has a high precision (few false positives) but it extracts few true positives, the utility of the recommendations remains limited.

While this has been described with reference to the embodiments above, a person of ordinary skill in the art would understand that various changes or modifications may be made thereto without departing from the scope of the claims.

1. A method for identifying social relationships between users remote to one another and interacting through a social platform, wherein the relationship between users is identified using temporal analysis that identifies a users' activeness.

2. The method of claim 1, wherein activeness between users is defined by a users' temporal coherence.

3. The method of claim 1, wherein the users' activeness is represented by user feature vectors.

4. The method of claim 1, wherein Aᵤ(i) represents the activeness of user u on the ith in the equation Aᵤ=[Aᵤ(1), Aᵤ(2), . . . , Aᵤ(T)].

5. The method of claim 1, wherein users' activeness is related to a number of messages a user posts.

6. The method of claim 1, wherein users' activeness is related to a frequency of a number of messages a user posts.

7. The method of claim 1, wherein users' activeness is related to a number of URLs a user tags.

8. The method of claim 1, wherein users' activeness is related to a frequency of a number of URLs a user tags.

9. The method of claim 1, wherein users' activeness is related to a number of comments a user makes.

10. The method of claim 1, wherein users' activeness is related to a frequency of a number of comments a user makes.

11. The method of claim 1, wherein the users' activeness is penalized.

12. The method of claim 11, wherein the users' activeness is penalized for posting comments above a threshold.

13. The method of claim 1, wherein the users' activeness is measured as a ratio of a user's participation to participation of other users.

14. A method for identifying social relationships between at least two users remote to one another and interacting through a social platform, wherein the relationship between users is identified using spectral analysis that identifies a coupling between two users.

15. The method of claim 14, wherein the spectral analysis includes a spectral coherence score between users' feature vectors that is used to represent relationships between the users.

16. The method of claim 15, wherein the spectral coherence score between two users represents a similarity of two users across all frequencies.

17. The method of claim 14, wherein the activeness of a user is quantified by calculating a spectrum of a user.

18. The method of claim 14, further comprising creating a network of users based on the couplings between users.

19. The method of claim 18, wherein the network is created using mutual top-K filtering.

20. The method of claim 18, wherein the network is created using thresholding.
